(19) United States
(12) Patent Application Publication
(10) Pub. No.: US 2011/0089209 A1
(43) Pub. Date: Apr. 21, 2011

(54) Body

(76) Inventor: Wade Keith Dallas, East Palatka, FL (US)

(21) Appl. No.: 12/589,291

(22) Filed: Oct. 21, 2009

(51) Int. Cl. B60R 11/00

(52) U.S. Cl. 224/487

(57) ABSTRACT

A five way multi-functional apparatus for cars, trucks, suvs and atvs. It's name is The Body. It's design allow for one to facilitate which device to use. All five functions constructs from one unit mounted into the receiver or tow hitch of the above mentioned vehicles. It's functions are that of a deer loading apparatus that assist the hunter in loading the deer after The Kill, a skinning rack for dressing; The Partybrella a detachable umbrella for tailgating or just getting out of the sun, and The Skyseat an elevated hunting stand to hunt from. The lower receiver assembly erects from zero to ninety degrees where each function or attachment is inserted in the top of. Each component folds for minimal space usage.

### CROSS-REFERENCE TO RELATED APPLICATION

This present application claims benefit from U.S. provisional application No. 61/196,843, filed Oct. 21, 2008 entitled The Body.

### BACKGROUND OF THE INVENTION

The present invention relates generally to a receiver hitch assembly with multi usages from cars, trucks, suv's and all-terrain vehicles

Any vehicle equipped with a tow or receiver hitch, has the potential to access or use each piece of equipment from one common bar. The lower receiver bar.

Auto and (ATV) manufacturers usually install only two different sizes of receiver assemblies on their various models due to their load or pulling capacities. Tow hitch manufacturers has made ready the difference in the two by way of adaptors.

The lower receiver unit of the present claimed benefit application can be quickly attached and detached in seconds by way of a retaining pin and a permanently mounted quick wrench.

### SUMMARY OF THE INVENTION

The principle object of this present invention is to provide an atmosphere in multiple ways by way of a vehicle tow hitch assembly; namely hunting, fishing, and tailgating.

One lower receiver unit that can be used with any vehicle provided it has an already mounted tow hitch or receiver unit in tact.

The lower receiver unit can be installed or removed as needed.

This present invention provides and make easier the task of a number of outdoor activities.

1 and 2. A deer skinning apparatus.

3. A rotating arm designed for loading wild game after the kill.

4. A tailgating or an apparatus that provides shade.

5. A apparatus for fishing, capable of holding fishing rods and reels.

6. An attachable, detachable hunting stand which allows for one to hunt from; by way of a ladder and seat.

For a full understanding of this present invention, reference should now be made to the following detailed description of the preferred embodiments of the invention as illustrated in the accompanying drawing.

### BRIEF DESCRIPTION OF THE DRAWING

FIG. (1) is a two part assembly diagram, showing the basic perspective of the present invention.

Their names and functions are as follows:

### DETAILED DESCRIPTION OF THE PREFERRED EMBODIMENT

(1) Is the receiver unit that mounts into the tow unit or receiver assembly.

(2) Is a flange for erecting and tightening upper and lower receiver assembly.

(3) Is a quick wrench that is permanently mounted to pull flanges together for tightness.

(4) Is the fixed vertical part of (1) when erected.

(5) Is the support lip that support the weight of 10, 24, 26 and 27 when in use.

(6) Are adjustment holes for FIGS. 10, 24, 26 and 27.

(7) Showing an arrow starting from zero degrees and ending at ninety degrees.

(8) Is the support chain that keep 1 and 4 together and also bares the weight of all lower units.

(9) Receiver locking hole, that allows the receiver to be locked in place by a locking pin.

(10) Lower overkill bar, that allow for extension to overkill unit or apparatus.

(11) Is the support bar, that support the weight of 10 and 13.

(12) Is the eyelet that allow a hoist to be hung for the hoisting of wild game.

(13) Is the upper overkill bar, where the load is suspended and the eyelet is attached.

(14) Showing an arrow starting from zero degrees and ending at ninety degrees, to lower overkill bar and upper overkill bar.

(15) Is the stud plate. It allows for the mounting of 21 and 27.

(16) Is the stud. It allows for the mounting of 21 and 27.

(17) Is a quick wrench that is permanently mounted to pull the flanges together for tightness. ,

(18) Is the receiver assembly or tow hitch and is not a part of patent. It's shown merely for reference.

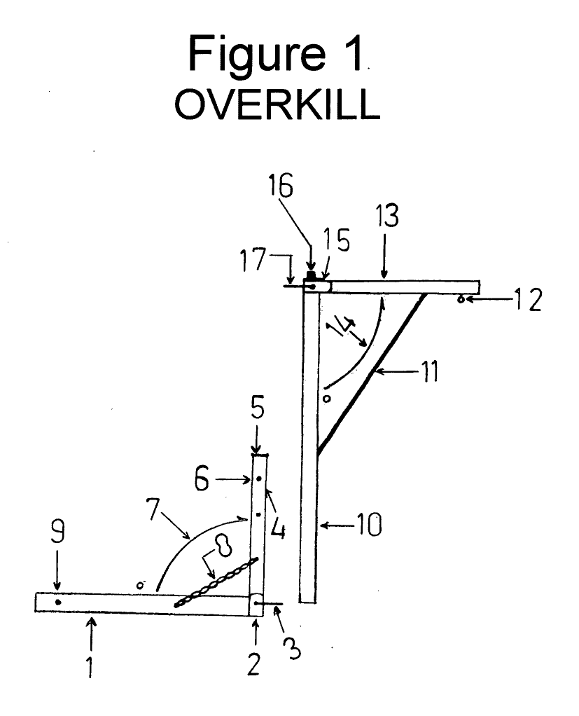

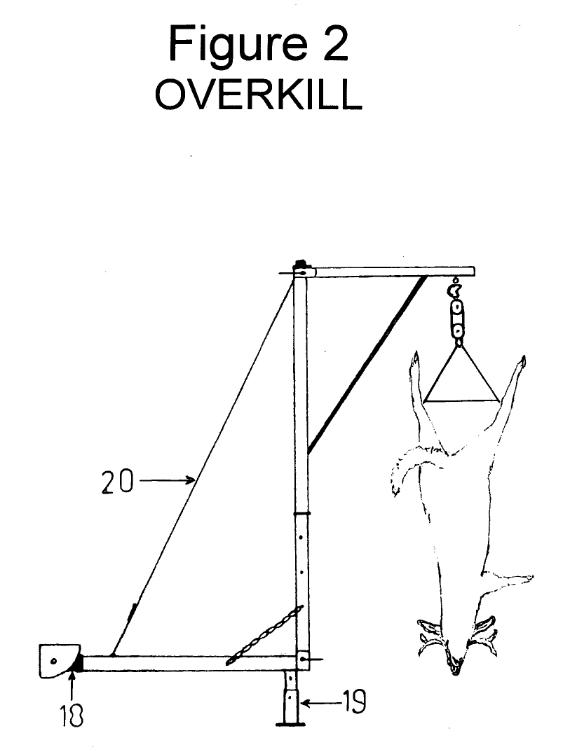

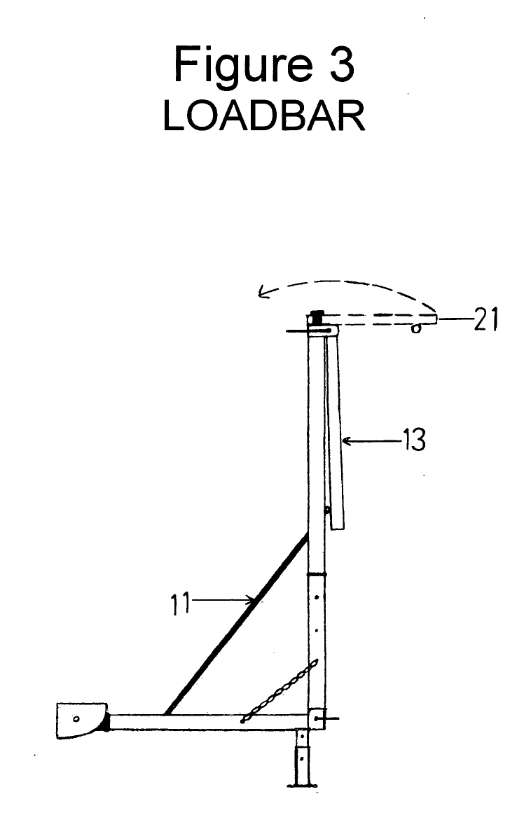

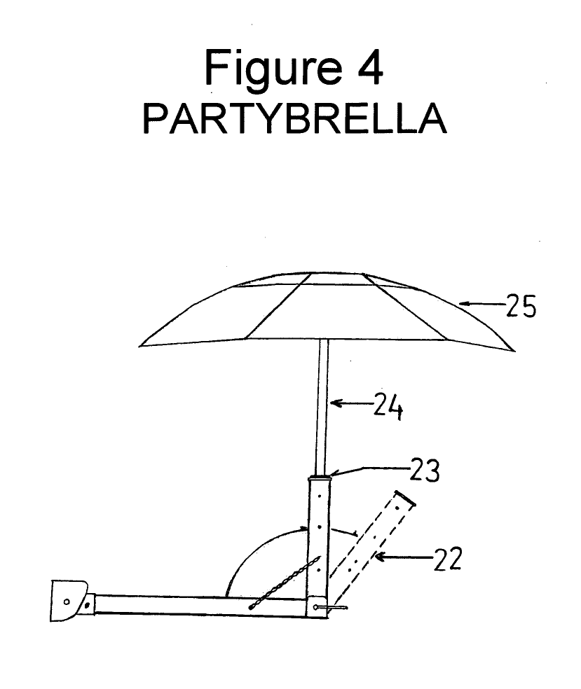

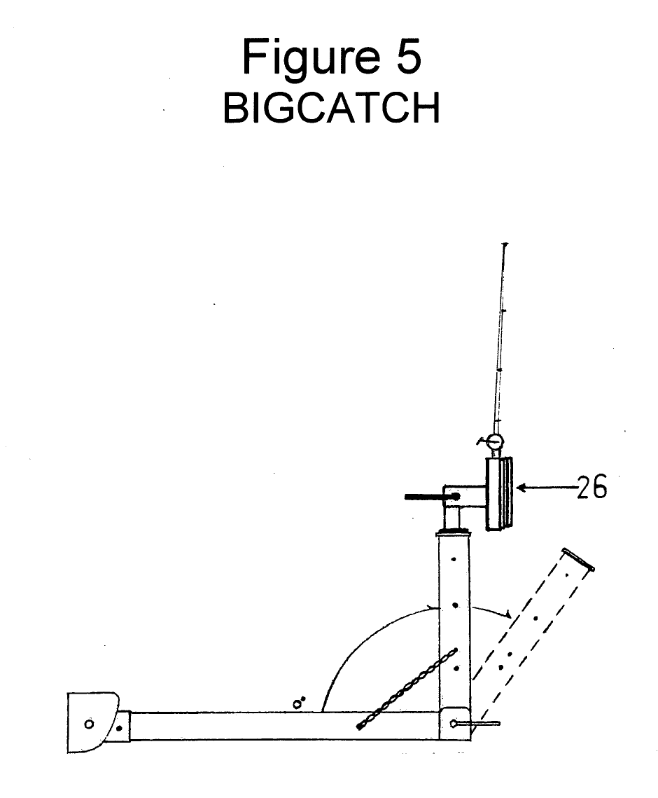

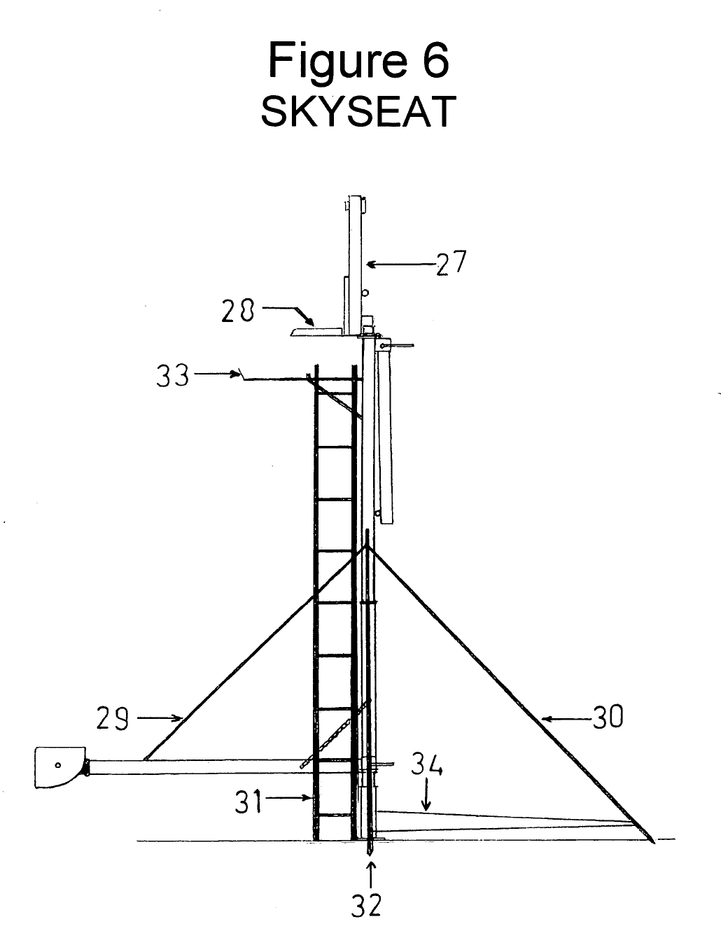

(19) Is the support jack. It support the load of FIG. 2 overkill, FIG. 3 load bar assembly, and FIG. 6 sky seat assembly.

(20) Is the safety strap. It support 1 to 13 when skinning of wild game.

(21) Is a position shown when 25 and 26 is utilized. When 25 is used it provides for a different angle or position of fishing gear, namely reel and rods.

(23) is a plastic filler cap, that fill open space of 24 and 26.

(24 and 25) Is the umbrella assembly installed into 2 and is called the partybrella

(26) Is the reel and rod holder shown installed into 4 and is called the Big Catch.

(27) Is 21 mounted in a vertical fashion to support 28.

(28) Is the seat where the hunter sits

(29, 30 and 32 are support legs. They support and stabilize FIG. 6 the sky seat.

(31) Is the access ladder, by which the hunter use to reach the elevated 28.

(33) Is the foot rest. It is used to rest the feet of the hunter on.

(34) Is the safety cables or chains that disallows the support legs from spreading beyond it's normal operating position.

What I claim is:

1. An apparatus with five different devices comprising five different functions. Constructing to and from, much like that of a transformer in order to achieve the desired device. These said devices all constructs from a receiver hitch or sometimes better known as a tow hitch; both are commonly viewed on the rear end of or underneath the bumper of trucks, cars and attached to the rear of all terrain vehicles. These devices constructs primarily from said constructed or erected by way of metal components such as metal pins, support bars, flanges, plastic components, support lips, quick wrenches, chains, nuts and bolts, support straps, and are designed to adjust and or slide by way of adjustment holes. Below, all devices are named along with additional claims of each. Their names are as follows: The Overkill, The Loading Bar, The Partybrella, The Big Catch and The Skyseat.
